(19) United States
(12) Patent Application Publication
(10) Pub. No.: US 2006/0121880 A1
(43) Pub. Date: Jun. 8, 2006

(54) Method and apparatus for enabling authorized and billable message transmission between multiple communications environments

(76) Inventors: Lawrence C. Cowsar, Summit, NJ (US); Michael E. Flaster, Tenafly, NJ (US); Clifford E. Martin, Martinsville, NJ (US); Wim Sweldens, New Providence, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/006,157

(22) Filed: Dec. 7, 2004

(51) Int. Cl. H04M 11/00

(52) U.S. Cl. 455/406; 455/411

(57) ABSTRACT

A method and apparatus for enabling message transmission between multiple communication environments such as the Internet and a wireless communications network, wherein user authentication and billing may be performed and wherein access rights associated with one environment may be advantageously inherited by another. The method enables the transmission of electronic messages (such as e-mail or SMS text messages) by registering two or more individual identities, each represented by a communications handle (such as an e-mail address or a mobile phone number), and by associating each of these two or more registered identities with each other, binding them into an equivalence class of identities, wherein one or more attributes of at least one of these identities becomes associated with the other identity. Illustratively, a sender-pays business (i.e., billing) model for e-mail to mobile message transmission and access rights to an internal enterprise database from a mobile phone are advantageously enabled.

### FIELD OF THE INVENTION

The present invention relates generally to the field of multimedia (e.g., text, images and/or audio) messaging and more particularly to a method and apparatus for enabling the transmission of messages, such as, for example, e-mail or SMS (Short Message Service) text messages, between multiple environments, such as, for example, the Internet and a mobile communications network (e.g., a cellular phone network), with user identity authentication for security and/or billing purposes.

### BACKGROUND OF THE INVENTION

The use of text messaging has become widespread, not only in the personal computer realm, but also in the realm of handheld wireless devices including mobile communications devices (e.g., cell phones). Short message service (SMS), for example, is a well known protocol by which mobile subscribers can communicate text messages to each other when, for example, voice communication is not practical or desirable. For example, SMS messaging may be used by a subscriber to communicate with another subscriber who is in a meeting or in conference and unable to engage in a voice call.

With the prevalence of personal computer based e-mail, typically communicated across a traditional data network such as the Internet using the Simple Mail Transfer Protocol (SMTP) over the Internet Protocol (IP), as well as the up-and-coming popularity of text and multimedia messaging for mobile devices such as cell phones, typically communicated across a wireless telephone network with use of protocols such as the SMS and MMS (Multimedia Messaging Service) protocols, it has become desirable to enable intercommunication between these fundamentally different environments. (Each of the SMTP, IP, SMS and MMS protocols are fully familiar to those of ordinary skill in the art.) For example, a cell phone user may wish to send a text message to a given e-mail address, and a user of a personal computer (or other Internet connected computing device) may wish to send a (preferably short) e-mail to a given cell phone number. In both of these cases, the intercommunication between the different networks necessarily involves the use of a gateway between the two networks.

In the United States, there are some open e-mail to mobile gateways without authentication (which would guarantee the identity of the sender). However, such open gateways are often plagued by spam and identity spoofing which threatens their long term viability and utility.

In other parts of the world, however, the typical business model for mobile phone messaging is that only the sender pays. Hence, there are usually no open e-mail to cell phone gateways since there would be no billable party for e-mail originated messages to cell phones. Instead, e-mail to mobile messaging is more typically enabled, for example, either by having special client software running on the device used to send the e-mail, or are based on sending messages through a web-based form after the sender has authenticated himself or herself to the web server.

### SUMMARY OF THE INVENTION

In accordance with the principles of the present invention, a novel method and apparatus for enabling the transmission of messages between communication environments such as the Internet and a mobile communications network is provided, wherein user authentication and appropriate billing may be advantageously performed without the need for the installation of special client software, and wherein access rights associated with one environment may be advantageously inherited by another environment. Illustratively, the principles of the present invention advantageously enable, for example, a sender-pays business (i.e., billing) model for e-mail to mobile message transmission, such as has been adopted by many carriers for mobile to mobile messaging. In addition, the principles of the present invention advantageously enable, for example, a mobile phone to gain access rights to an internal enterprise database.

More specifically, a method for enabling the transmission of electronic messages (such as, for example, e-mail, or “instant messaging” or SMS text messages), in accordance with the principles of the present invention, comprises the steps of registering two or more individual identities, one of which is represented by a first communications handle (such as, for example, an e-mail address, an instant message handle, or a cellular phone number) and one of which is represented by a second communications handle (also, such as, for example, an e-mail address, an instant message handle, or a cellular phone number); and associating each of these two or more registered identities with each other, thereby binding the individual identities into an equivalence class of identities, wherein one or more attributes of at least one of these identities becomes associated with the other identity. For example, an attribute comprising billing information for a first identity representative of a communications handle which comprises a mobile phone number, may advantageously become associated with a second identity representative of a communications handle which comprises an e-mail address, thereby enabling a user of the second identity to send a message from the e-mail address but to be charged for the transmission in accordance with the billing information attribute associated with the mobile phone number. Alternatively, an attribute comprising access rights of -a first identity representative of a communications handle which comprises an enterprise-linked e-mail address, may advantageously become associated with a second identity representative of a communications handle which comprises a mobile phone number, thereby granting enterprise access rights to the mobile phone.

In particular, in accordance with one illustrative embodiment of the invention, a message delivery gateway (MDGW) implements the above-described functionality of transmitting e-mail to a mobile phone and thereby advantageously provides, inter alia, a communications gateway between a traditional data network such as the Internet and a conventional wireless network such as a mobile (i.e., cellular) phone network. Such an illustrative MDGW advantageously enables a given user on the data network (e.g., the Internet) to send an e-mail or an instant message to a mobile phone and to have his or her own mobile phone account billed for the cost of sending the message.

And in accordance with another illustrative embodiment of the invention, a message delivery gateway (MDGW) implements the above-described functionality of transmitting a query message from a mobile phone to an enterprise server and transmitting a reply from the enterprise server back to the mobile phone. Such an illustrative MDGW advantageously enables a given mobile phone user who also has an enterprise-linked e-mail address to gain access rights to an internal enterprise database such as, for example, an employee telephone directory.

### BRIEF DESCRIPTION OF THE DRAWINGS

FIG. 1 shows a flowchart of a first illustrative method according to the present invention, wherein authenticated and billable e-mail to mobile phone message transmission is advantageously enabled.

FIG. 2 shows an example of a communications environment in which a message delivery gateway enables the transmission of an e-mail message to a mobile phone in accordance with the first illustrative embodiment of the present invention shown in FIG. 1.

FIG. 3 shows a flowchart of a second illustrative method according to the present invention, wherein a mobile phone is advantageously granted enterprise access rights associated with an e-mail address.

FIG. 4 shows an example of a communications environment in which a message delivery gateway enables the granting of enterprise access rights associated with an enterprise-linked e-mail address to a mobile phone in accordance with the second illustrative embodiment of the present invention shown in FIG. 3.

### DETAILED DESCRIPTION OF THE ILLUSTRATIVE EMBODIMENTS

Introduction

We first note that, in accordance with the principles of the present invention, two independent “planes” of communication may be advantageously converged such that properties of one plane are advantageously inherited by properties of the other. In particular, and in accordance with the illustrative embodiments of the present invention described below, the user's “communications handles” (i.e., mobile phone numbers on the one hand, and e-mail addresses and/or instant messaging handles on the other hand) are advantageously bound together into an equivalence class of identities.

Thus, for example, a billing relationship that exists with the end user in the mobile phone plane may be advantageously brought into the electronic message plane and associated with use of the e-mail address. That is, a user can send an e-mail which requires billing (e.g., to a mobile phone under a “sender pays” business model), without requiring special client software. Moreover, network access rights that are associated with an end user in the electronic mail plane may be advantageously granted to a user in the mobile phone plane. In particular, an e-mail address associated with a given enterprise may imply that the individual is an employee of the enterprise, which in turn allows access to certain enterprise services (e.g., an on-line employee directory listing), which may then, for example, become advantageously accessible through SMS messages sent from a mobile phone bound thereto.

### An Illustrative Method in Accordance with a First Embodiment of the Invention

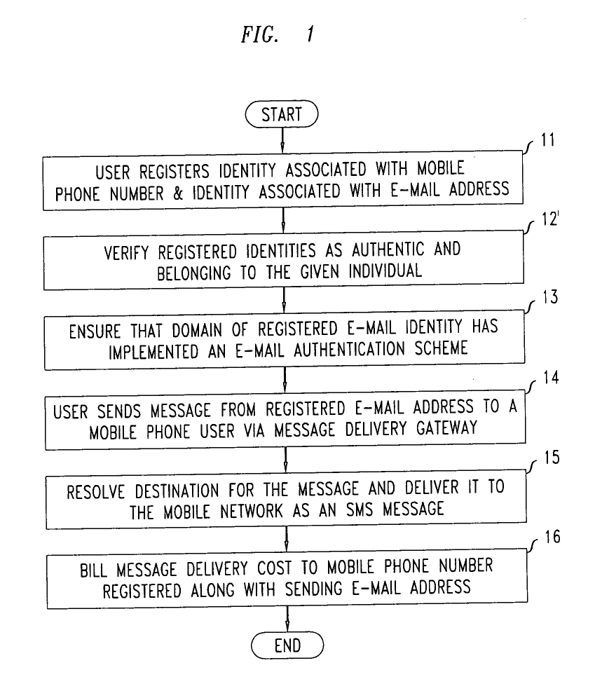

FIG. 1 shows a flowchart of a first illustrative method according to the present invention, wherein authenticated and billable e-mail to mobile phone message transmission is advantageously enabled. In particular, the method of FIG. 1 enables a user to send an e-mail message to a mobile phone user, having the sender's mobile phone number billed for the cost of delivering the message. The method as shown in the figure may, for example, be realized by a system implemented in software executing on appropriate computing hardware (e.g., a CPU with memory and external persistent storage). More specifically, such an illustrative system advantageously implements the following functionality, as shown in the figure:

1. As shown in block 11 of FIG. 1, a given user registers two or more identities including one associated with one or more mobile devices (e.g., a cell phone number) as well as one associated with one or more e-mail addresses and/or instant messaging (IM) handles.

2. As shown in block 12 of FIG. 1, the addresses associated with the registered identities are verified as authentic and as belonging to the individual registering them. For example, this may be done by sending a message containing a different unique secret (key or word) to each registered identity and then requiring that the registering user enter those secrets into a webpage authorizing his identity.

3. As shown in block 13 of FIG. 1, each e-mail domain of the registered addresses which is to be enabled to send e-mail is then required (for anti-spoofing and billing purposes) to implement an e-mail authentication mechanism, such as, for example, Sender ID, Sender Policy Framework or SMIME, each of which is fully familiar to those skilled in the art.

4. As shown in block 14 of FIG. 1, the user can then send a message from any of his or her registered identities addressed, for example, to a mobile phone user (who does not need to be registered as described above in accordance with the illustrative embodiment of the present invention). For example, in accordance with one illustrative embodiment of the invention, the (e-mail like) address “9085555555@mdgw.com” may be used for addressing a message destined for delivery on a mobile phone having the assigned phone number of “908-555-5555.” Note that the use of “mdgw.com” in this example represents a Message Delivery Gateway (MDGW), which may illustratively serve as a communications gateway for transmitting e-mail to a mobile phone in accordance with an illustrative embodiment of the present invention. Due to the above-described authentication from the e-mail domain (see step 3), the e-mail can be reliably trusted as being from the given registered user and therefore no further authentication is needed for the message to be processed by the gateway.

5. As shown in block 15 of FIG. 1, the destination for the message is resolved (with use, for example, of the “enum” service, fully familiar to those skilled in the art) and the message is delivered to the mobile messaging network as, for example an SMS message or, alternatively, a MMS message.

6. As shown in block 16 of FIG. 1, the cost for the message delivery service is billed to the mobile phone number associated with an identity which the given user registered (as one of his or her identities) along with the registration of the identity two registered identities have been “bound” together for billing purposes.

Note that even though the user's message in the above-described scenario was sent from one of the email addresses, the registration of an identity associated with a mobile phone along with the registration of an identity associated with the e-mail address advantageously enables a business model where the sender may be billed as if the message had been sent directly from his or her mobile device. In other illustrative embodiments of the invention, other billing plans as the service provider may see fit to implement may be employed instead.

### Other Illustrative Embodiments of the Invention Related to the First Embodiment

In accordance with another illustrative embodiment of the present invention, if a receiver of a message sent as described above (in accordance with the above-described illustrative embodiment of the invention) has also registered multiple identities corresponding to multiple avenues of communication (e.g., mobile messaging, instant messaging (IM) handles, e-mail addresses), then the receiver may advantageously specify how the message should be delivered depending on a set of policies and preferences. For example, merely by way of examples, (i) he or she may have indicated that the message should be delivered by IM if his or her IM presence indicates that he or she is currently online, but otherwise to his or her mobile phone, (ii) he or she may have indicated that the message should be delivered to a particular e-mail address during working hours, but to his or her mobile phone at all other times, and/or (iii) he or she may have indicated various types of content transformations that should be executed under various conditions. Numerous other such policy and preference choices will be obvious to those of ordinary skill in the art.

And in accordance with another illustrative embodiment of the present invention, even if a receiver of a message sent as described above is not registered with multiple identities, he or she may specify delivery policies which might, for example, include a “friendlist” procedure for controlling who is authorized to send messages to his or her mobile device. (As is well known to those of ordinary skill in the art, a friendlist is a list of possible message senders, the list being associated with a particular possible message receiver, who are approved for sending messages to the particular receiver.)

### A Communications Environment in Accordance with the First Embodiment

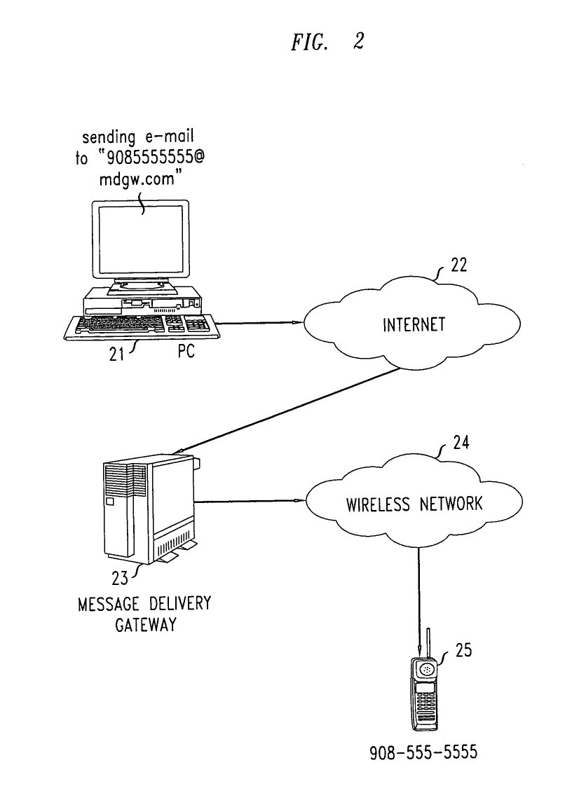

FIG. 2 shows an example of a communications environment in which a message delivery gateway enables the transmission of an e-mail message to a mobile phone in accordance with the first illustrative embodiment of the present invention shown in FIG. 1. In particular, as pointed out above, message delivery gateway 23 may, for example, comprise a CPU with memory and external persistent storage having executable software stored thereon, such that the execution of the software illustratively implements the functionality described above and shown in FIG. 1.

As illustratively shown in FIG. 2, PC (personal computer) 21 is used by a given user to send an e-mail having as its destination mobile phone 25, which has “908-555-5555” as its associated mobile phone number. In accordance with the principles of the present invention, the given user has advantageously registered both an identity associated with the e-mail address from which the e-mail shown is being sent, as well as an identity associated with the given user's mobile phone number, and these individual identities have been advantageously bound together for security and billing purposes. Therefore, as shown in the figure, the e-mail message being sent from PC 21 is sent via data network 22 (i.e., the Internet) to message delivery gateway 23, which, in accordance with the principles of the present invention, allows the message to be sent via wireless network 24 to mobile phone 25 (having the specified mobile phone number).

### An Illustrative Method in Accordance with a Second embodiment of the Invention

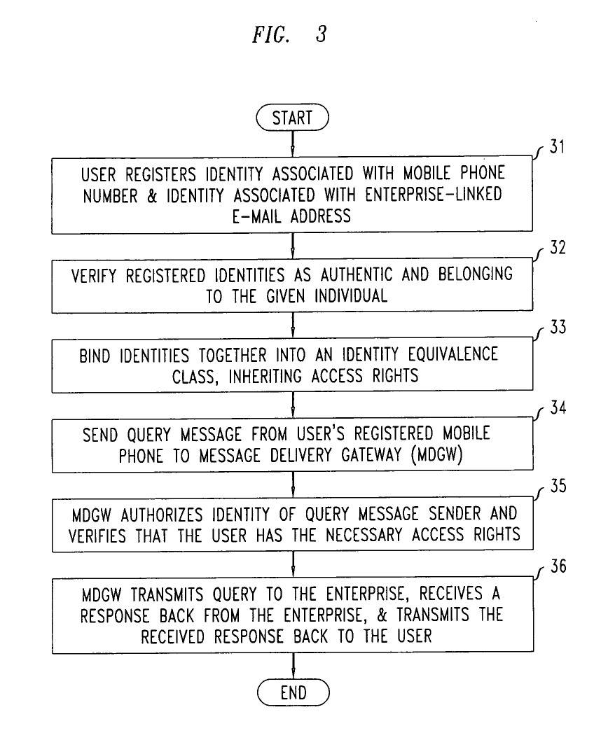

FIG. 3 shows a flowchart of a second illustrative method according to the present invention, wherein a mobile phone is advantageously granted enterprise access rights associated with an e-mail address. In particular, the method of FIG. 3 enables a mobile phone user to gain access rights to certain enterprise services based on his or her having bound an identity represented by a mobile phone number to another identity represented by an enterprise-linked e-mail address (such as, for example, name@company.com, where name is the “handle” of an employee of a company known as company) into an equivalence class of identities. By way of example, the mobile phone user may advantageously receive access rights (through the mobile phone itself) to an internal company telephone directory, based on the mobile phone identity having been bound to the enterprise-linked e-mail address identity.

The method as shown in the figure may, for example, be realized by a system implemented in software executing on appropriate computing hardware (e.g., a CPU with memory and external persistent storage). More specifically, such an illustrative system advantageously implements the following functionality, as shown in the figure:

1. As shown in block 31 of FIG. 3, a given user registers two or more identities including one associated with a mobile device. (e.g., a cell phone number) as well as one associated with an enterprise-linked e-mail addresses.

2. As shown in block 32 of FIG. 3, the addresses associated with the registered identities are verified as authentic and as belonging to the individual registering them.

3. As shown in block 33 of FIG. 3, the addresses associated with the registered identities are bound together into an equivalence class of identities, wherein access rights associated with one of the identities (e.g., the one associated with an enterprise-based e-mail address) are advantageously inherited by another one of the identities (e.g., the one associated with a mobile phone).

4. As shown in block 34 of FIG. 3, the user sends a query message from his or her mobile phone to a message delivery gateway. The query message may, for example, comprise a request for information from a private enterprise database such as an employee telephone directory.

5. As shown in block 35 of FIG. 3, the message delivery gateway authorizes the identity of the sender of the query message and verifies that the user has the access rights being requested (as a result of the identity of the query sending user having been bound with an identity having such access rights).

6. As shown in block 36 of FIG. 3, the message delivery gateway (assuming that the necessary access rights have been verified) transmits the query to the given enterprise, receives a response to the query back from the enterprise, and transmits the received response back to the user (e.g., to the user's mobile phone).

### A Communications Environment in Accordance with the Second Embodiment

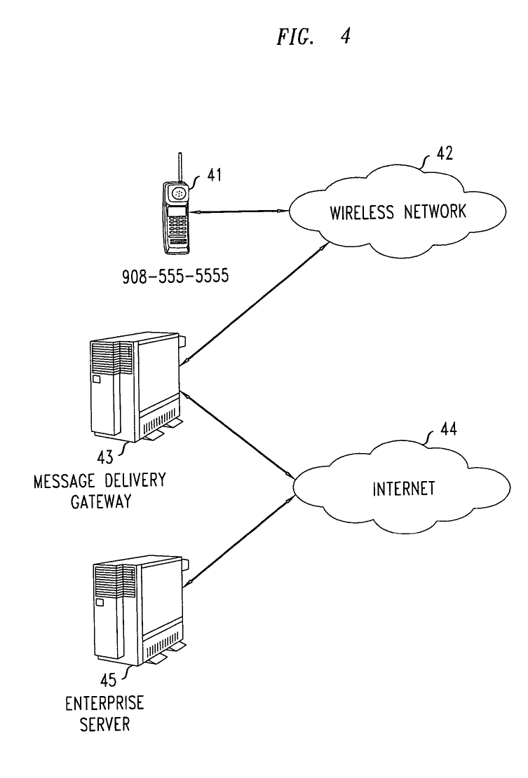

FIG. 4 shows an example of a communications environment in which a message delivery gateway enables the granting of enterprise access rights associated with an enterprise-linked e-mail address to a mobile phone in accordance with the second illustrative embodiment of the present invention shown in FIG. 3. In particular, as pointed out above message delivery gateway 43 may, for example, comprise a CPU with memory and external persistent storage having executable software stored thereon, such that the execution of the software illustratively implements the functionality described above and shown in FIG. 3.

As illustratively shown in FIG. 4, mobile phone 41 is used by a given user to send a query message to message delivery gateway 43 requesting certain information associated with a given enterprise (having enterprise server 45 as one of its servers). In accordance with the principles of the present invention, the given user has advantageously registered both an identity associated with the given user's mobile phone number, as well as an identity associated with an enterprise-linked e-mail address (linked to the enterprise associated with enterprise server 45), and these individual identities have been advantageously bound together such that access rights associated with the enterprise-linked e-mail address have been inherited by the mobile phone number.

Therefore, as shown in the figure, the query message being sent from mobile phone 41 is sent via wireless network 42 to message delivery gateway 43, which, in accordance with the principles of the present invention, transmits the message via data network 44 (i.e., the Internet) to enterprise server 45. Enterprise server 45, in turn, provides a reply to the query message via data network 44 to message delivery gateway 43, which then transmits the reply back to mobile phone 41 via wireless network 42.

### Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. Furthermore, all examples and conditional language recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

Thus, for example, it will be appreciated by those skilled in the art that any flow charts, flow diagrams, state transition diagrams, pseudocode, and the like represent various processes which may be substantially represented in computer readable medium and so executed by a computer or processor, whether or not such computer or processor is explicitly shown. Thus, the blocks shown, for example, in such flowcharts may be understood as potentially representing physical elements, which may, for example, be expressed in the instant claims as means for specifying particular functions such as are described in the flowchart blocks. Moreover, such flowchart blocks may also be understood as representing physical signals or stored physical data, which may, for example, be comprised in such aforementioned computer readable medium such as disc or semiconductor storage devices.

We claim:

1. A method for enabling the transmission of an electronic message comprising the steps of:
registering a plurality of user identities associated with a given user, the plurality of user identities comprising at least a first user identity and a second user identity, the first user identity represented by a first communications handle and the second user identity represented by a second communications handle; and
associating each of the plurality of user identities together, thereby binding at least the first and second user identities into an equivalence class of identities, such that one or more attributes of the second user identity becomes associated with the first user identity.

2. The method of claim 1 wherein the first communications handle comprises an electronic address and the second communications handle comprises a mobile phone number, and wherein the method enables the transmission of an electronic message from said electronic address to a mobile phone number identified as a destination of said electronic message.

3. The method of claim 2 wherein said electronic address comprises an e-mail address.

4. The method of claim 2 wherein said electronic address comprises an instant messaging handle.

5. The method of claim 2 wherein said one or more attributes of the second user identity comprises billing account information associated with said mobile phone number representing the second user identity.

6. The method of claim 5 further comprising the step of verifying the authenticity of one or more of said plurality of user identities.

7. The method of claim 6 wherein said step of verifying the authenticity of one or more of said plurality of user identities comprises verifying the authenticity of the first user identity by:
(a) sending a message to said electronic address representing said first user identity, the message comprising a secret, and
(b) verifying that the given user has accurately confirmed the receipt of said secret by supplying the secret to a predetermined website.

8. The method of claim 5 further comprising the step of verifying that said electronic address representing said first user identity has an e-mail authentication scheme associated therewith.

9. The method of claim 5 further comprising the steps of:
receiving an electronic message from said electronic address representing said first user identity, said electronic message being directed to said mobile phone number identified as the destination of said electronic message, and
transmitting said received electronic message to said mobile phone number identified as the destination of said electronic message.

10. The method of claim 9 further comprising the step of billing an account identified by said billing account information associated with said mobile phone number representing said second user identity, for a cost associated with said transmitting of said received electronic message to said mobile phone number identified as the destination of said electronic message.

11. The method of claim 1 wherein the first communications handle comprises a mobile phone number and the second communications handle comprises an enterprise-linked e-mail address, and wherein the method enables the transmission of a query message from said mobile phone number to an enterprise associated with said enterprise-linked e-mail address.

12. The method of claim 11 wherein said one or more attributes of the second user identity comprises electronic access rights associated with said enterprise associated with said enterprise-linked e-mail address.

13. The method of claim 12 further comprising the step of verifying the authenticity of one or more of said plurality of user identities.

14. The method of claim 13 wherein said step of verifying the authenticity of one or more of said plurality of user identities comprises verifying the authenticity of the second user identity by:
(a) sending a message to said electronic address representing said first user identity, the message comprising a secret, and
(b) verifying that the given user has accurately confirmed the receipt of said secret by supplying the secret to a predetermined website.

15. The method of claim 12 further comprising the steps of:
receiving a query message from said mobile phone number representing said first user identity, said query message being directed to said enterprise associated with said enterprise-linked e-mail address, and
transmitting said received query message to said enterprise associated with said enterprise-linked e-mail address.

16. The method of claim 15 wherein said query message comprises a request for information from an enterprise database associated with said enterprise associated with said enterprise-linked e-mail address.

17. The method of claim 16 wherein said enterprise database associated with said enterprise associated with said enterprise-linked e-mail address comprises an employee telephone directory.

18. The method of claim 15 further comprising the steps of:
receiving a response to said query message from said enterprise associated with said enterprise-linked e-mail address, and
transmitting said received response back to said mobile phone number representing said first user identity.

19. A message delivery gateway adapted to enable the transmission of an electronic message, the message delivery gateway comprising a processor adapted to:
register a plurality of user identities associated with a given user, the plurality of user identities comprising at least a first user identity and a second user identity, the first user identity represented by a first communications handle and the second user identity represented by a second communications handle; and
associate each of the plurality of user identities together, thereby binding at least the first and second user identities into an equivalence class of identities, such that one or more attributes of the second user identity becomes associated with the first user identity.

20. The message delivery gateway of claim 19 wherein the first communications handle comprises an electronic address and the second communications handle comprises a mobile phone number, and wherein the message delivery gateway enables the transmission of an electronic message from said electronic address to a mobile phone number identified as a destination of said electronic message.

21. The message delivery gateway of claim 20 wherein said electronic address comprises an e-mail address.

22. The message delivery gateway of claim 20 wherein said electronic address comprises an instant messaging handle.

23. The message delivery gateway of claim 20 wherein said one or more attributes of the second user identity comprises billing account information associated with said mobile phone number representing the second user identity.

24. The message delivery gateway of claim 23 wherein the processor is further adapted to verify the authenticity of one or more of said plurality of user identities.

25. The message delivery gateway of claim 24 wherein the processor is adapted to verify the authenticity of one or more of said plurality of user identities by verifying the authenticity of the first user identity by:
(a) sending a message to said electronic address representing said first user identity, the message comprising a secret, and
(b) verifying that the given user has accurately confirmed the receipt of said secret by supplying the secret to a predetermined website.

26. The message delivery gateway of claim 23 wherein the processor is further adapted to verify that said electronic address representing said first user identity has an e-mail authentication scheme associated therewith.

27. The message delivery gateway of claim 23 wherein the processor is further adapted to:
receive an electronic message from said electronic address representing said first user identity, said electronic message being directed to said mobile phone number identified as the destination of said electronic message, and
transmit said received electronic message to said mobile phone number identified as the destination of said electronic message.

28. The message delivery gateway of claim 27 wherein the processor is further adapted to bill an account identified by said billing account information associated with said mobile phone number representing said second user identity, for a cost associated with said transmitting of said received electronic message to said mobile phone number identified as the destination of said electronic message.

29. The message delivery gateway of claim 19 wherein the first communications handle comprises a mobile phone number and the second communications handle comprises an enterprise-linked e-mail address, and wherein the message delivery gateway enables the transmission of a query message from said mobile phone number to an enterprise associated with said enterprise-linked e-mail address.

30. The message delivery gateway of claim 29 wherein said one or more attributes of the second user identity comprises electronic access rights associated with said enterprise associated with said enterprise-linked e-mail address.

31. The message delivery gateway of claim 30 wherein the processor is further adapted to verify the authenticity of one or more of said plurality of user identities.

32. The message delivery gateway of claim 31 wherein the processor is adapted to verify the authenticity of one or more of said plurality of user identities by verifying the authenticity of the second user identity by:
(a) sending a message to said electronic address representing said first user identity, the message comprising a secret, and
(b) verifying that the given user has accurately confirmed the receipt of said secret by supplying the secret to a predetermined website.

33. The message delivery gateway of claim 30 wherein the processor is further adapted to:
receive a query message from said mobile phone number representing said first user identity, said query message being directed to said enterprise associated with said enterprise-linked e-mail address, and
transmit said received query message to said enterprise associated with said enterprise-linked e-mail address.

34. The message delivery gateway of claim 33 wherein said query message comprises a request for information from an enterprise database associated with said enterprise associated with said enterprise-linked e-mail address.

35. The message delivery gateway of claim 34 wherein said enterprise database associated with said enterprise associated with said enterprise-linked e-mail address comprises an employee telephone directory.

36. The message delivery gateway of claim 33 wherein the processor is further adapted to:
receive a response to said query message from said enterprise associated with said enterprise-linked e-mail address, and
transmit said received response back to said mobile phone number representing said first user identity.
